(19) United States
(12) Patent Application Publication
(10) Pub. No.: US 2022/0227087 A1
(43) Pub. Date: Jul. 21, 2022

(54) METHOD FOR PRODUCING A COMBINATION SOLE-INSOLE COMPONENT FOR A SHOE

(71) Applicant: OneFID GmbH, Lichtenfels (DE)

(72) Inventors: Christoph Kraus, Lichtenfels (DE); Oliver Hofmann, Lichtenfels (DE)

(21) Appl. No.: 17/614,115

(22) PCT Filed: May 28, 2019
(86) PCT No.: PCT/EP2019/063842

§ 371 Date: Nov. 24, 2021

(51) Int. Cl. B29D 35/12; A43B 13/04; B33Y 80/00

(52) U.S. Cl. CPC B29D 35/122; B33Y 80/00; A43B 13/04

(57) ABSTRACT

A method for manufacturing a combined sole/insole part for a shoe, which comprises a sole element and an insole element that is formed integrally therewith, said method comprising the following steps of: providing insole element data which describe the geometric/constructive design of an insole element of a sole/insole part to be manufactured, wherein the insole element data were generated on the basis of foot data which describe, at least in portions, optionally fully, the morphology of at least one foot of a wearer; and providing sole element data which describe the geometric/constructive design of a sole element of a sole/insole part to be manufactured, additively manufacturing a combined sole/insole part on the basis of the insole element data and the sole element data.

### CROSS REFERENCE TO RELATED APPLICATIONS

The present specification is a National Phase Entry of International Application No. PCT/EP2019/063842 filed May 28, 2019 and entitled “Method For Producing A Combination Sole-Insole Component For A Shoe” the entirety of which is incorporated by reference herein.

### FIELD

The present specification relates to a method for the additive manufacture of a combined sole/insole part for a shoe, which comprises a sole element and an insole element that is formed integrally therewith.

### BACKGROUND

In order to manufacture shoe components or shoes, various manufacturing approaches are known from the prior art.

Hitherto, corresponding approaches provide for the manufacture of individual shoe components, and the connection of these, forming the shoe to be manufactured in each case, in separate work or manufacturing process steps. Accordingly, up to now respective shoe components of a shoe to be manufactured, i.e. in particular insole and sole elements, are manufactured separately from one another, within the text of the manufacture of the shoe, typically in at least one first work or manufacturing process step, and interconnected in at least one separate further work or manufacturing process step.

This approach leaves room for improvement in view of manufacture of a shoe that is as efficient as possible, and therefore there is a need for development here. This also applies in particular against the background of manufacture of a shoe that can be or is configured in a manner as individualizable or individualised as possible.

In particular, a principle of efficient manufacture of a combined sole/insole part for a shoe, which comprises a sole element and an insole element that is formed integrally therewith, would be desirable, the properties of which sole/insole part can be configured in a manner as individualizable or individualised as possible.

### SUMMARY

The object of the present specification is that of specifying an improved method for manufacturing a sole/insole part for a shoe, or a shoe.

The object is achieved by a method for additive manufacture of a combined sole/insole part for a shoe according to claim 1, and a method for producing a shoe according to claim 11. The claims dependent thereon in each case relate to possible embodiments of the respective methods.

A first aspect of the embodiments described herein relates to a method for the additive manufacture of a combined sole/insole part for a shoe. The combined sole/insole part which can be or is manufactured according to the method (referred to in the following, for short, as “sole/insole part”) forms a component of a shoe; the sole/insole part can thus be referred to or considered as a shoe component. As is clear in the following, in connection with the manufacture of a shoe, the sole/insole part can be connected to at least one further shoe component, in particular a shoe construction element, in particular an upper element that forms a component of an upper of a shoe. Accordingly, in order to manufacture a shoe, the sole/insole part, as explained in the following in connection with a further aspect of the embodiments described herein, is to be connected to at least one further shoe component.

The sole/insole part comprises at least one insole element and at least one sole element which is formed integrally therewith. The sole element can also be referred to or considered as a sole portion of the sole/insole part, and the insole element can also be referred to or considered as an insole portion of the sole/insole part. Thus, the sole/insole part assumes two different functionalities, specifically both the functionality of a sole element and the functionality of an insole element. The sole/insole part can thus be considered or referred to, generally, as an integrated part.

In particular with respect to a construction of a shoe of which the sole/insole part forms a component, the sole element of the sole/insole part may be a midsole element or an outer sole element (outsole element). In the embodiment as a midsole element, the sole element does not comprise any outer surface or tread which is in contact with a substrate in the worn state of a shoe equipped with the sole/insole part; in the embodiment as an outsole element, the sole element comprises an optionally profiled outer surface or tread which is in contact with a substrate in the worn state of a shoe equipped with the sole/insole part.

In particular with respect to a construction of a shoe of which the sole/insole part forms a component, the insole element of the sole/insole part may be an inner sole element. In the worn state of a shoe equipped with the sole/insole part, the insole element accordingly forms the contact surface for a foot of a wearer. This also applies for the conceivable embodiment in which the insole element is provided, at least in portions, optionally completely, with a functional layer consisting of a functional material, such as a leather material, a textile material, etc., in a contact surface region that faces a foot of a wearer, with respect to the construction of a shoe equipped with the sole/insole part. In connection with the insole element, it should therefore be mentioned that this typically comprises a closed contact surface region for a foot of a wearer.

The sole element and/or the insole element can be designed, independently of one another, as a structure comprising one or more openings, or as a closed structure that does not comprise any openings.

According to the method, the sole/insole part is manufactured additively, i.e., using or implementing at least one additive manufacturing process. In principle all additive manufacturing processes are possible in this case. For example, additive manufacturing processes are possible which allow for additive processing of powdery construction material or of non-powdery, i.e. in particular stranded, construction material. Furthermore, by way of example, additive manufacturing processes are possible which allow for radiation-based additive manufacture, i.e., additive manufacture which selective hardening of construction material under the influence of energetic radiation (radiation energy), or non-radiation-based additive manufacture, i.e. additive manufacture which selective hardening of construction material without the influence of energetic radiation (radiation energy).

Since the sole/insole part is typically, but in no way essentially, manufactured, at least in portions, in particular completely, from a plastics material (the term “plastics material” also includes mixtures of chemically and/or physically different plastics materials)—the insole element and the sole element are typically made of the same material—in particular those additive manufacturing processes which allow for additive processing of plastics materials also come into consideration. Merely by way of example reference is made in this connection to stereolithography processes, binder jetting processes, fused deposition modelling (“FDM”) processes, or continuous liquid interface production (“CLIP”) processes. The sole/insole part can thus be manufactured for example by means of a stereolithography process, binder jetting process, fused deposition modelling (“FDM”) process, or a continuous liquid interface production (“CLIP”) process. Thus, in order to carry out the second step of the method, explained in greater detail in the following, for example additive manufacturing apparatuses, which are designed for performing stereolithography processes, binder jetting processes, FDM processes, or CLIP processes, can be used.

Should the sole/insole part be manufactured at least in portions, in particular completely, from a material different from a plastics material, i.e. for example a metal, accordingly those additive manufacturing processes which allow for additive processing of at least one material different from a plastics material come into consideration. Merely by way of example reference is made to selective laser sintering methods, selective laser melting methods, metal binder jetting methods, etc.

The method specifically comprises the following steps:

In a first step of the method, insole element data and sole element data are provided. The provision can take place for example via a data medium or a data connection, such as a local or global data network, i.e. for example an Intranet or the Internet. The provision of the insole element data and sole element data typically takes place on an additive manufacturing apparatus or a controller that is associated therewith and is hardware and/or software-implemented, which controller is designed for data processing of the insole element data and sole element data provided thereto, for preparing and/or carrying out an additive manufacturing process.

The provided insole element data describe the geometric/constructive design of an insole element which, as mentioned, forms a component of the sole/insole part to be manufactured. The insole element data typically contain all the geometric/constructive parameters of the insole element of the sole/insole part to be manufactured. The insole element data can also be referred to, considered, or used as construction data of the insole element. The insole element data can be provided in any file format; merely by way of example reference is made to STL, COLLADA, OBJ, FBX and X3D formats.

The insole element data are or were generated basis of foot data which describe, at least in portions, optionally fully, the morphology of at least one foot of a wearer. The insole element data thus describe the morphology of the at least one foot described by the foot data, or a geometric/constructive design of the insole element, which is adjusted, at least in portions, optionally fully, to the morphology of the at least one foot described by the foot data. According to the method, the insole element can thus be designed, at least in portions, optionally completely, on the basis of corresponding insole element data, in a manner having a geometric/constructive design which is designed so as to be individually configured with respect to a foot of a user. Taking into account corresponding foot data (these can be established for example on the data of optical recordings (scans) of the foot, imprints of the foot, etc.) when generating the insole element data forms the basis for (highly) individualizable or (highly) individualised manufacture of the sole/insole part.

The provided sole element data describe the geometric/constructive design of a sole element which, as mentioned, forms a component of the sole/insole part to be manufactured. The sole element data typically contain all the geometric/constructive parameters of the sole element of the sole/insole part to be manufactured. The sole element data can also be referred to, considered or used as construction data of the sole element. The sole element data can also be provided in any file format; merely by way of example reference is made to STL, COLLADA, OBJ, FBX and X3D formats.

It is of course possible for the insole element data and the sole element data to be provided as a common dataset which contains both the insole element data and the sole element data. Accordingly, a corresponding common dataset typically contains all the geometric/constructive parameters of the sole/insole part.

In a second step of the method, additive manufacture of a sole/insole part takes place, on the basis of the insole element data and the sole element data or a corresponding common dataset. Thus, in the second step of the method the actual manufacture of the sole/insole part takes place, by applying at least one additive manufacturing method for manufacturing the sole/insole part. In this case it is essential for the sole/insole part to be manufactured in a productionally simple manner, in a single additive manufacturing process, which results in the one-piece or integral or monolithic configuration of the sole/insole part; the insole element and the sole element are thus manufactured together, in a single additive manufacturing process, forming the sole/insole part; this results in the integral design of the sole/insole part which is characterised in that the insole element is non-detachably connected to the sole element, and vice versa. The additive manufacturing process applied for manufacturing the sole/insole part thus includes additive formation of the insole element and of the sole element, which are manufactured within the context of the additive manufacturing process as a combined part and are thus manufactured so as to be integrally interconnected in a non-detachable manner (without damage or destruction). The insole element and the sole element thus directly adjoin one another or transition directly into one another. Thus, for an arrangement or orientation, by way of example, of the sole/insole part in a construction space of an additive manufacturing apparatus, the insole element can be constructed directly on the sole element, or vice versa. However, depending on the arrangement or orientation of the sole/insole part in a construction space of an additive manufacturing apparatus, other construction strategies, in which portions of the insole element and of the sole element are constructed for example simultaneously (in a layer-based manner), are also conceivable.

Overall, a highly efficient method for manufacturing a sole/insole part is provided, which simultaneously allows for a foot-specifically individualizable or individualised configuration of an insole element.

Insole elements can be provided which describe a geometric/constructive design of the insole element which is formed at least in portions, in particular completely, by an ergonomic shaping selected in view of the morphology of the at least one foot described by the foot data. The insole element can thus for example be designed at least in portions, optionally completely, having a cushion that is configured individually in view of the foot morphology described by the foot data, which can improve the wearability of the sole/insole part.

Sole element data can be provided which describe a geometric/constructive design of the sole element which is formed, at least in portions, in particular completely, by a structural element arrangement comprising a plurality of interconnected strut-like or strut-shaped structural elements. The sole element can thus be manufactured in the form of a structural element arrangement described by the sole element data, which comprises, at least in portions, in particular completely, by a plurality of interconnected strut-like or strut-shaped structural elements. The strut-like or strut-shaped structural elements are referred to for short in the following as “structural elements”. As is explained in greater detail in the following, different configurations of a corresponding structural element arrangement make it possible to purposely achieve different structural, i.e. in particular mechanical, properties of the sole element and thus of the sole/insole part, which can improve the wearability of the sole/insole part.

The insole element can be manufactured having an insole element region which is formed around an edge, at least in portions, optionally completely, and which is raised in particular with respect to a reference plane (this can be defined for example by a contact surface region of the insole element), which insole element region surrounds the foot of a wearer around the periphery (of the foot), at least in portions, in the worn state of the sole/insole part. The wearability of the sole/insole part can be improved in this way too.

The sole element and/or the insole element can be manufactured at least in portions, optionally completely, having a plurality of zones having different geometric/constructive and/or different structural properties, i.e. in particular mechanical properties. For example, at least one zone can be designed for a forefoot region, at least one zone for a midfoot region, and at least one zone for a hind foot region (heel region), which regions may differ in their structural properties, i.e. in particular in their mechanical properties. In this way, a highly individual configuration of the sole/insole part is achieved, as a result of which the wearability of the sole/insole part can be improved. Corresponding zones can in particular be designed in a wearer-specifically individualised manner, such that these are designed, for a wearer desiring for example increased damping in a midfoot region, in a manner having different structural properties, i.e. for example increased damping, at least in the zones relating to the midfoot region, compared with the case of a wearer desiring for example increased damping in a hind foot region.

It has been mentioned that sole element data can be provided which describe a geometric/constructive design of the sole element which is formed, at least in portions, in particular completely, by a structural element arrangement comprising a plurality of interconnected strut-like or strut-shaped structural elements. The structural properties of the sole element, i.e. in particular the mechanical properties of the sole element that define the damping properties or the degree of hardness or deformation, can thus substantially result from the geometric/constructive construction of the structural element arrangement, i.e. in particular the number and/or arrangement and/or orientation of respective structural elements. Accordingly, the structural properties of the sole element, i.e. in particular the mechanical properties of the sole element that define the damping properties or the degree of hardness or deformation, can be purposely set by purposeful selection or variation in the number and/or arrangement and/or orientation of respective structural elements. In particular, a purposeful selection by region or zone, or a purposeful variation, by region or zone, of the arrangement and/or orientation of respective structural elements makes it possible to achieve any number of regions or zones, i.e. for example one or more regions or zones for a forefoot region, one or more regions or zones for a midfoot region, and one or more regions or zones for a hind foot region (heel region), having different structural properties, i.e. in particular different mechanical properties. It is therefore possible to achieve sole/insole parts which have structural properties, i.e. in particular mechanical properties, which are or can be adapted individually for a wearer, i.e. in particular also for a particular foot of a wearer.

The strut-like or strut-shaped geometric/constructive basic shape of the structural elements typically results from an elongate basic shape of the structural elements. The elongate basic shape of a respective structural element can be formed by an extension of the relevant structural element which is straight at least in portions, optionally completely, and/or by an extension of the relevant structural element which extends in a curved manner at least in portions, optionally completely.

Various configurations are possible in view of the cross-sectional geometry of respective structural elements. A structural element can be designed for example having a polygonal, i.e. in particular square, cross-sectional geometry; in principle, however, other, i.e. for example circular or round, cross-sectional geometries are also conceivable. Of course, different structural elements can be formed, having different cross-sectional geometries; different structural elements can thus have different cross-sectional geometries. It is likewise conceivable for a (single) structural element to be formed having different cross-sectional geometries; a (single) structural element can thus be formed having portions of different cross-sectional geometries.

As is clear in the following, different structural elements can differ in terms of their geometric/constructive properties, i.e. for example in their geometric dimensions, i.e. in particular length, width, thickness (height), such that, on account of different geometric dimensions, different structural elements have different structural properties, i.e. in particular different mechanical properties.

As is clear from the above discussions, a corresponding structural element arrangement can be formed having identical or different structural elements in identical or different arrangements and/or orientations.

A corresponding structural element arrangement can thus be designed for example having first and second structural elements. The first structural elements can be arranged or formed in a first spatial direction or spatial orientation, the second structural elements can be arranged or formed in a second spatial direction or spatial orientation that is different from the first spatial direction or spatial orientation. The first spatial direction or spatial orientation can for example be a vertical spatial direction or spatial orientation defined by a vertical spatial axis, the second spatial direction or spatial orientation can be a horizontal spatial direction or spatial orientation defined by a horizontal spatial axis. The first structural elements can thus be arranged or oriented so as to be angled, i.e. for example at right-angles, with respect to the second structural elements (and vice versa), and vice versa.

Of course, a corresponding structural element arrangement can be formed having further structural elements in addition to corresponding first and second structural elements, which are arranged or formed in at least one further spatial direction or spatial orientation that is different from the first and second spatial direction or spatial orientation, i.e. for example in a spatial direction or spatial orientation that extends obliquely with respect to a vertical and/or horizontal spatial direction or spatial orientation. As is clear in the following it is also possible, however, for first and/or second structural elements to be arranged or formed in a spatial direction or spatial orientation that extends obliquely with respect to a vertical and/or horizontal spatial direction or spatial orientation.

In particular on account of the different arrangement and orientation thereof, corresponding first and second structural elements can be designed so as to be differently functionalised, i.e. so as to have different functions. The first structural elements can for example be arranged or designed to transmit forces acting on the sole/insole part during use as intended, i.e. in particular compression forces. The second structural elements can thus also be referred to or considered as force transmission elements, i.e. in particular as compression force transmission elements. The second structural elements can for example be arranged or designed to damp acting on the sole/insole part during use as intended, i.e. in particular compression forces. The second structural elements can thus (also) be referred to or considered as damping elements.

A corresponding structural element arrangement can, as indicated, additionally be formed having third structural elements which differ functionally from the first and second structural elements. Corresponding third structural elements can be arranged or designed as tensile force transmission elements designed for transmitting tensile forces that act on the sole/insole part, in particular in the longitudinal direction of the sole/insole part, and/or as tensile force transmission elements designed for transmitting tensile forces resulting inside the sole/insole part, in particular acting in the longitudinal direction of the sole/insole part. The third structural elements can thus also be referred to or considered as tensile force transmission elements. The third structural elements can in particular be formed between two second structural elements, which are in particular arranged or formed so as to be in parallel.

Corresponding third structural elements can be arranged or formed in a third spatial direction or spatial orientation. The third spatial direction or spatial orientation can be a horizontal spatial direction or spatial orientation defined by a horizontal spatial axis. The third spatial direction or spatial orientation can thus correspond to the second spatial direction or spatial orientation of the second structural elements.

Corresponding first structural elements and/or second structural elements can be formed in a segmented manner. First and/or second structural elements can thus be formed having at least two structural element segments, which are in particular arranged so as to extend in parallel, at least in portions. A segmented design of the structural elements, it being conceivable for just first or just second structural elements, or both first and second structural elements, to be formed in a segmented manner, makes it possible to influence the structural properties of the sole/insole part, i.e. in particular the mechanical properties of the sole/insole part, in a more purposeful manner.

Respective structural element segments can be arranged or formed in pairs. This applies in particular for structural element segments which are arranged or formed in parallel. First and/or second structural elements can thus be designed having a plurality of pairs of structural element segments which are arranged or formed so as to be in parallel. At least two structural element segments which are arranged or formed in parallel can form a structural element segment pair.

Irrespective of the possible segmented design thereof, first structural elements and/or second structural elements can be designed so as to extend obliquely with respect to a horizontal or vertical reference axis or plane. A course of respective structural elements which is designed so as to be correspondingly oblique with respect to a horizontal or vertical reference axis or plane, or for the case of the segmented design of respective structural element segments, also constitutes a measure for purposeful influencing of the structural properties of the sole/insole part, i.e. in particular the mechanical properties of the sole/insole part, since for example other damping properties can result from the oblique course. Accordingly, in particular the second structural elements that are arranged or formed as damping elements can be designed so as to be arranged in a manner extending obliquely with respect to a horizontal or vertical reference axis or plane. In this case it is conceivable for upper second structural elements, with respect to an upper face of the sole/insole part, to be designed in a manner arranged so as to extend obliquely, with respect to a corresponding reference axis or plane, at a different angle compared with lower second structural elements, with respect to an upper face of the sole/insole part.

A combination of the segmented design and of the course of the respective structural elements which is arranged so as to be oblique with respect to a horizontal or vertical reference axis or plane is also conceivable. Therefore, first structural elements and/or second structural elements can be formed by at least two structural element segments, which are in particular arranged to as to extend in parallel, at least in portions, or can comprise at least two structural element segments, which are in particular arranged so as to extend in parallel, at least in portions, and the respective structural element segments of the respective first structural element, and/or the respective second structural element segments of the respective second structural element, are designed so as to be arranged in a manner extending obliquely with respect to a horizontal or vertical reference axis or plane.

For a segmented structural element formed by a plurality of corresponding structural element segment pairs, it is the case that a first structural element segment pair can be designed so as to extend at a first angle with respect to a horizontal or vertical reference axis or plane, and a second structural element segment pair can be designed so as to extend at a second angle, different from the first angle, with respect to a horizontal or vertical reference axis or plane.

A defined arrangement and orientation of corresponding first and second structural elements makes it possible for a combined force transmission/damping substructure to be formed. Thus, on account of the first structural elements which, as mentioned, function as force transmission elements, the combined force transmission/damping substructure, referred to for short in the following as “substructure”, has both force transmission properties and, on account of the second structural elements which, as mentioned, function as damping elements, also damping properties. The substructure is thus characterised both by a force transmission function and by a damping function.

In an embodiment given by way of example, the substructure can be formed for example by two first structural elements, i.e. two force transmission elements, and two second structural elements, i.e. two damping elements. The two force transmission elements can be formed so as to be arranged in an orientation in parallel with the direction of a force acting on the sole/insole part (direction of action of force), in particular during use as intended of the sole/insole part. The two damping elements can be formed so as to be arranged in an orientation transverse to the direction of a force acting on the sole/insole part (direction of action of force), in particular during use as intended of the sole/insole part.

The damping properties of a respective damping element arrangement result in particular from the dimensions, i.e. in particular the thickness, of the damping elements forming said arrangement, as well as the spacing between the damping elements forming said arrangement. Therefore, the geometric dimensions, i.e. in particular the thickness, of the damping elements, and the mutual spacing thereof, provide parameters for purposeful selection and setting of particular damping properties of the damping element arrangement. Selecting and setting the parameters accordingly makes it possible for, for example, a particular deformation, i.e. in particular a maximum deformation, of the damping element arrangement to be defined for a particular force acting on the damping element arrangement.

Forces are typically introduced into the damping element arrangement by means of respective force transmission elements of a respective substructure. A first force transmission element can be arranged relative to a first damping element, adjacent thereto, such that forces can be transmitted into the damping element arrangement thereby. A second force transmission element can be arranged relative to a second damping element, adjacent thereto, such that forces can be transmitted thereto from the damping element arrangement.

In this case, the two damping elements of a substructure can be formed so as to be in parallel with one another, forming a damping element arrangement. Providing different damping element arrangements makes it possible for locally different damping properties to be formed, in zones.

On account of the typically vertical orientation of the force transmission elements, as mentioned, and the typically horizontal orientation of the damping elements, as mentioned, a double T-structure can thus result for a substructure, in which the horizontally extending portions of the “T”, formed by the damping elements, are designed so as to be arranged in a manner lying on one another, and the vertically extending portions of the “T”, formed by the force transmission elements, are designed so as to be arranged in a manner aligned with one another in the vertical direction.

A corresponding structural element arrangement can be formed having a plurality of corresponding substructures, wherein a plurality of substructures can form a substructure arrangement. The substructures are typically formed so as to be arranged in a (common) plane of the sole/insole part.

In addition to the structural elements, the sole element can be designed having a plurality of planar, in particular plate-like or plate-shaped, force introduction elements designed for introducing, into at least one respective substructure, a force which acts on the sole/insole part during use as intended. Respective planar force introduction elements, referred to for short in the following as “force introduction elements”, may have a polygonal, i.e. in particular square, basic shape. Respective force introduction elements can be arranged or formed on an upper and/or a lower face of a structural element arrangement. Therefore, first force introduction elements are formed on an upper face of the structural element arrangement, and second force introduction elements are formed on a lower face of the structural element arrangement. Respective force introduction elements arranged or formed on an upper or a lower face of a structural element arrangement are typically not directly interconnected. A space can therefore be formed between force introduction elements that are arranged or formed on an upper or a lower face of a structural element arrangement so as to be directly adjacent. As a result, introducing a force into a first force introduction element does not necessarily cause the introduction of a force into a second force introduction element that is formed so as to be directly adjacent to the first force introduction element.

The force introduction elements can be designed for introducing a force, acting on the sole, into the force transmission elements (first structural elements) of a respective substructure, and accordingly connected to at least one force transmission element; thus, typically at least one first structural element is connected to respective force introduction elements. The respective first structural element typically protrudes, in the vertical direction, from an upper or lower face of a respective force introduction element facing the structural element arrangement, in the direction of the damping elements.

A unit cell of the sole element can be formed by corresponding force introduction elements and corresponding substructures. A unit cell can be referred to or considered as a geometric/constructive basic module of the sole element. A unit cell is typically formed by a plurality of substructures which are arranged and oriented in a (common) plane of the sole and so as to be rotated or offset relative to one another by a particular angle, i.e. for example an angle of 90°, as well as a plurality of force introduction elements that are arranged or formed on the upper and lower face of said substructures. The substructures of a unit cell can, in particular in the region of the ends thereof, be interconnected by means of, in particular block-like, connection regions. The force introduction elements typically form the upper and lower face of a respective unit cell. The substructures typically form the sides of a respective unit cell.

Depending on the specific dimensions of the individual components of the unit cell, a respective unit cell can be formed for example having a cuboid-like or cuboid-shaped basic shape, i.e. in particular having a cube-like or cube-shaped basic shape. The edge or side length of a corresponding cuboid-like or cuboid-shaped unit cell can for example be in a range between 5 and 15 mm, in particular between approximately 10 mm. The height of a corresponding cuboid-like or cuboid-shaped unit cell can likewise be for example in a range between 5 and 15 mm, in particular between approximately 10 mm. Unit cells having larger or smaller dimensions are conceivable.

A specific embodiment of a corresponding unit cell can comprise four substructures which are arranged and oriented so as to be rotated and offset relative one another by 90°, which substructures form a substructure arrangement. A first force introduction element is formed on the top of said substructure arrangement, and a second force introduction element is formed on the bottom thereof. The unit cell thus comprises four substructures and two force introduction elements. The substructures form the side faces of the unit cell, the first force introduction element forms the upper face, the second force introduction element forms the lower face of the unit cell. The unit cell has a cuboid-like or cuboid-shaped basic shape, i.e. in particular a cube-like or cube-shaped basic shape.

The structural properties, i.e. in particular the mechanical properties, of a respective unit cell are defined by the structural properties, i.e. in particular the mechanical properties, the components of the unit cell, as well as the arrangement and orientation thereof relative to one another.

The sole element can be formed having a plurality of unit cells which are identical or different with respect to the geometric/constructive properties thereof, i.e. in particular the dimensions thereof, and/or the structural properties thereof, i.e. in particular the mechanical properties thereof. Respective unit cells can thus exhibit the same geometric/constructive properties and the same structural properties. It is also conceivable, however, for respective unit cells to exhibit the same geometric/constructive properties and the different structural properties. Similar applies for unit cells of having different geometric/constructive properties, i.e. that the unit cells exhibit different geometric/constructive properties and the same structural properties, or different geometric/constructive properties and different structural properties.

Unit cells that are arranged so as to be directly adjacent can be interconnected by means of at least one connection region. A corresponding connection region can be formed for example in the region of respective damping elements or damping element arrangements of unit cells that are arranged so as to be directly adjacent. The connection between unit cells that are arranged so as to be directly adjacent can be non-detachable or detachable (without damage or destruction).

An arrangement of identical and different unit cells thus makes it possible for zones of identical or different geometric/constructive properties, and identical or different structural properties, i.e. in particular different mechanical properties, damping, degrees of hardness, degrees of deformation, etc., to be formed.

The sole element, and thus the sole/insole part, can accordingly (this applies in principle independently of respective unit cells) be formed so as to be divided into a plurality of zones of different geometric/constructive properties, as well as different structural properties. In particular, one or more zones can be formed for a forefoot region, one or more zones for a midfoot region, and or more zones for a hind foot region (heel region), wherein the zones may differ in their geometric/constructive properties and in their structural properties.

All the above discussions in connection with respective structural element arrangements apply analogously for the insole element; accordingly it is optionally possible, according to the method, for insole element data to be provided which describe a geometric/constructive design of the insole element, which is formed at least in portions, in particular completely, by a structural element arrangement comprising a plurality of interconnected strut-like or strut-shaped structural elements. All further discussions in connection with the sole element apply analogously for the insole element.

A further aspect of the embodiments described herein relates to a method for manufacturing a shoe. The method comprises the following steps:

manufacturing a combined sole/insole part for a shoe according to a method described herein for additive manufacture of a sole/insole part, or providing a sole/insole part manufactured according to a method as described herein for additive manufacture of a sole/insole part,

manufacturing at least one shoe construction element, in particular a shoe construction element that forms a component of a shoe upper, or providing at least one shoe construction element, in particular a shoe construction element that forms a component of a shoe upper,

connecting (in principle any interlocking, force-fitting and/or integral connection types come into consideration) the manufactured or provided combined sole/insole part to the at least one further shoe construction element, in particular the shoe construction element that forms a component of a shoe upper, forming a shoe to be manufactured.

In principle any type of shoe in any shoe size and fit can be produced using the method. Merely by way of example, reference is made to sports shoes, conventional shoes, or functional shoes, such as orthopaedic shoes.

According to the method, a further shoe construction element which encloses the foot of a wearer, in particular the instep of the foot of a wearer, at least in portions, optionally completely, can be manufactured or provided. Therefore, completely closed shoes, partially closed shoes, or open shoes, can be manufactured using the method.

According to the method, a further shoe construction element which is formed at least in portions, optionally completely, of a textile material structure, in particular a knitted fabric or woven fabric, can be manufactured or provided. The sole/insole part can thus be connected to a further shoe construction element which is formed at least in portions, optionally completely, of a textile material structure, in particular a knitted fabric or woven fabric.

Further aspects of the embodiments described herein relate to a sole/insole part produced according to the method according to the first aspect, and a shoe produced according to the method according to the second aspect. The respective discussions relating to the method apply analogously for the sole/insole part or the shoe.

### BRIEF DESCRIPTION OF THE DRAWINGS

Embodiments of the present specification will be explained in greater detail with reference to embodiments that are shown in the figures, in which:

FIG. 1 is a schematic view of a sole/insole part according to an embodiment;

FIG. 2 is a schematic view of a shoe according to an embodiment;

FIG. 3 is a flow diagram of a method according to an embodiment;

FIG. 4 is a schematic view of a sole element of a sole/insole part according to a first embodiment;

FIG. 5 is a schematic view of a sole element of a sole/insole part according to a first embodiment;

FIG. 6 is an enlarged view of the detail VI in FIG. 4;

FIG. 7 is an enlarged view of the detail VII in FIG. 5;

FIG. 8 is a structural element arrangement according to an embodiment; and

FIG. 9 is a structural element arrangement according to an embodiment.

### DETAILED DESCRIPTION

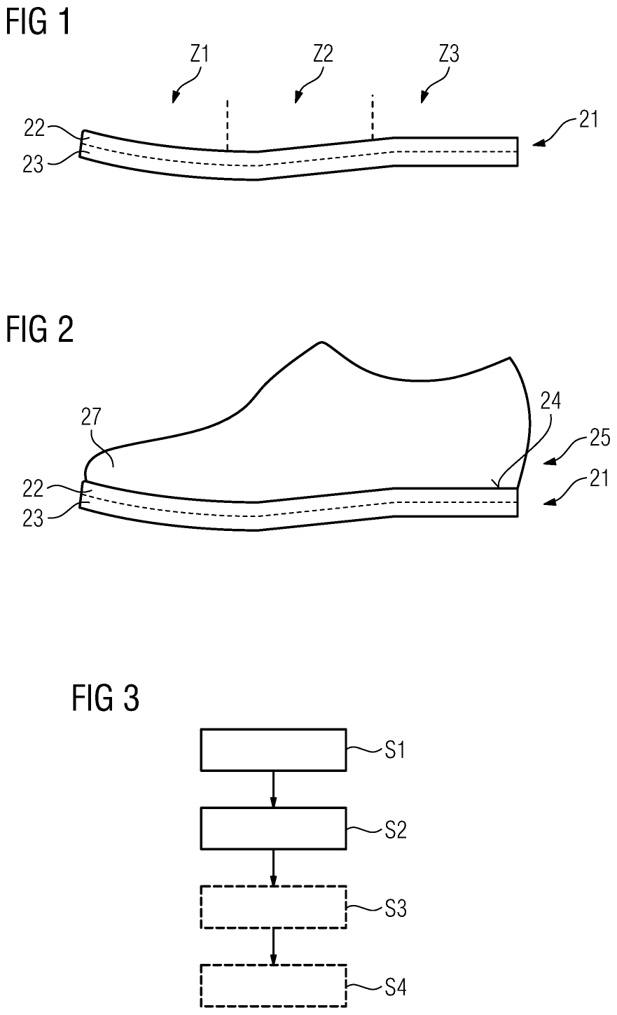

FIG. 1 is a purely schematic view of a combined sole/insole part 21 according to an embodiment. The sole/insole part 21 forms a component of a shoe 25 (cf. FIG. 2 which is also a purely schematic view of an embodiment of a shoe 25); the sole/insole part 21 can thus be referred to or considered as a shoe component.

It can be seen that the sole/insole part 21 comprises an insole element 22 and a sole element 23 which is formed integrally therewith. The sole element 23 can also be referred to or considered as a sole portion of the sole/insole part 21, and the insole element 22 can also be referred to or considered as an insole portion of the sole/insole part 21. Thus, the sole/insole part 21 assumes two different functionalities, specifically both the functionality of a sole element and the functionality of an insole element. The sole/insole part 21 can thus be considered or referred to, generally, as an integrated part.

In particular with respect to a construction of a shoe 25 of which the sole/insole part 21 forms a component, the sole element 23 of the sole/insole part 21 may be a midsole element or an outer sole element (outsole element). In the embodiment as a midsole element, the sole element 23 does not comprise any outer surface or tread which is in contact with a substrate in the worn state of a shoe 25 equipped with the sole/insole part 21; in the embodiment as an outsole element, the sole element 23 comprises an optionally profiled outer surface or tread which is in contact with a substrate in the worn state of a shoe 25 equipped with the sole/insole part 21.

In particular with respect to a construction of a shoe 25 of which the sole/insole part 21 forms a component, the insole element 22 of the sole/insole part 21 may be an inner sole element. In the worn state of a shoe 25 equipped with the sole/insole part 21, the insole element accordingly forms the contact surface for a foot of a wearer. This also applies for the conceivable embodiment in which the insole element 22 is provided, at least in portions, optionally completely, with a functional layer consisting of a functional material, such as a leather material, a textile material, etc., in a contact surface region 4 that faces a foot of a wearer, with respect to the construction of a shoe 25 equipped with the sole/insole part 21. In connection with the insole element 22 it should therefore be mentioned that this typically comprises a closed contact surface region 4 for a foot of a wearer.

FIG. 3 shows an embodiment of a method for manufacturing the sole/insole part 21. According to the method, the sole/insole part 21 is manufactured additively, i.e. using or implementing at least one additive manufacturing process. In principle all additive manufacturing processes are possible in this case. For example additive manufacturing processes are possible which allow for additive processing of powdery construction material or of non-powdery, i.e. in particular stranded, construction material. Furthermore, by way of example, additive manufacturing processes are possible which allow for radiation-based additive manufacture, i.e. additive manufacture which selective hardening of construction material under the influence of energetic radiation (radiation energy), or non-radiation-based additive manufacture, i.e. additive manufacture which selective hardening of construction material without the influence of energetic radiation (radiation energy).

Since the sole/insole part 21 is typically, but in no way essentially, manufactured, at least in portions, in particular completely, from a plastics material (the term “plastics material” also includes mixtures of chemically and/or physically different plastics materials)—the insole element 22 and the sole element 23 are typically made of the same material—in particular those additive manufacturing processes which allow for additive processing of plastics materials also come into consideration. Merely by way of example reference is made in this connection to stereolithography processes, binder jetting processes, fused deposition modelling (“FDM”) processes, or continuous liquid interface production (“CLIP”) processes. The sole/insole part can thus be manufactured for example by means of a stereolithography process, binder jetting process, fused deposition modelling (“FDM”) process, or a continuous liquid interface production (“CLIP”) process. Thus, in order to carry out the second step of the method, explained in greater detail in the following, for example additive manufacturing apparatuses, which are designed for performing stereolithography processes, binder jetting processes, FDM processes, or CLIP processes, can be used.

Should the sole/insole part 21 be manufactured at least in portions, in particular completely, from a material different from a plastics material, i.e. for example a metal, accordingly those additive manufacturing processes which allow for additive processing of at least one material different from a plastics material come into consideration. Merely by way of example reference is made to selective laser sintering methods, selective laser melting methods, metal binder jetting methods, etc.

The method specifically comprises the following steps:

In a first step of the method (cf. step S1), insole element data and sole element data are provided. The provision can take place for example via a data medium or a data connection, such as a local or global data network, i.e. for example an Intranet or the Internet. The provision of the insole element data and sole element data typically takes place on an additive manufacturing apparatus or a controller that is associated therewith and is hardware and/or software-implemented, which controller is designed for data processing of the insole element data and sole element data provided thereto, for preparing and/or carrying out an additive manufacturing process.

The provided insole element data describe the geometric/constructive design of an insole element 22 which, as mentioned, forms a component of the sole/insole part 21 to be manufactured. The insole element data typically contain all the geometric/constructive parameters of the insole element 22 of the sole/insole part 21 to be manufactured. The insole element data can also be referred to, considered or used as construction data of the insole element 22. The insole element data can be provided in any file format; merely by way of example reference is made to STL, COLLADA, OBJ, FBX and X3D formats.

The insole element data are or were generated basis of foot data which describe, at least in portions, optionally fully, the morphology of at least one foot of a wearer. The insole element data thus describe a geometric/constructive design of the insole element 22 which is adjusted, at least in portions, optionally fully, to the morphology of the at least one foot described by the foot data. According to the method, the insole element 22 can thus be designed, at least in portions, optionally completely, on the basis of corresponding insole element data, in a manner having a geometric/constructive design which is designed so as to be individually configured with respect to a foot of a user. Taking into account corresponding foot data (these can be established for example on the data of optical recordings (scans) of the foot, imprints of the foot, etc.) when generating the insole element data forms the basis for (highly) individualizable or (highly) individualised manufacture of the sole/insole part.

The provided sole element data describe the geometric/constructive design of a sole element 23 which, as mentioned, forms a component of the sole/insole part 21 to be manufactured. The sole element data typically contain all the geometric/constructive parameters of the sole element 23 of the sole/insole part 21 to be manufactured. The sole element data can also be referred to, considered or used as construction data of the sole element 23. The sole element data can also be provided in any file format; merely by way of example reference is made to STL, COLLADA, OBJ, FBX and X3D formats.

It is of course possible for the insole element data and the sole element data to be provided as a common dataset which contains both the insole element data and the sole element data. Accordingly, a corresponding common dataset typically contains all the geometric/constructive parameters of the sole/insole part 21.

In a second step of the method (cf. step S2), additive manufacture of a sole/insole part 21 takes place, on the basis of the insole element data and the sole element data or a corresponding common dataset. Thus, in the second step of the method the actual manufacture of the sole/insole part 21 takes place, by applying at least one additive manufacturing method for manufacturing the sole/insole part 21. In this case it is essential for the sole/insole part 21 to be manufactured in a productionally simple manner, in a single additive manufacturing process, which results in the one-piece or integral or monolithic configuration of the sole/insole part 21; the insole element 22 and the sole element 23 are thus manufactured together, in a single additive manufacturing process, forming the sole/insole part 21; this results in the integral design of the sole/insole part 21 which is characterised in that the insole element 22 is non-detachably connected to the sole element 23, and vice versa. The additive manufacturing process applied for manufacturing the sole/insole part 21 thus includes additive formation of the insole element 22 and of the sole element 23, which are manufactured within the context of the additive manufacturing process as a combined part and are thus manufactured so as to be integrally interconnected in a non-detachable manner (without damage or destruction). The insole element 22 and the sole element 23 thus directly adjoin one another or transition directly into one another. Thus, for an arrangement or orientation, by way of example, of the sole/insole part 21 in a construction space of an additive manufacturing apparatus, the insole element 22 can be constructed directly on the sole element 23, or vice versa. However, depending on the arrangement or orientation of the sole/insole part 21 in a construction space of an additive manufacturing apparatus, other construction strategies, in which portions of the insole element 22 and of the sole element 23 are constructed for example simultaneously (in a layer-based manner), are also conceivable.

Insole elements can be provided which describe a geometric/constructive design of the insole element 22 which is formed at least in portions, in particular completely, by an ergonomic shaping selected in view of the morphology of the at least one foot described by the foot data. The insole element 22 can thus for example be designed at least in portions, optionally completely, having a cushion that is configured individually in view of the foot morphology described by the foot data.

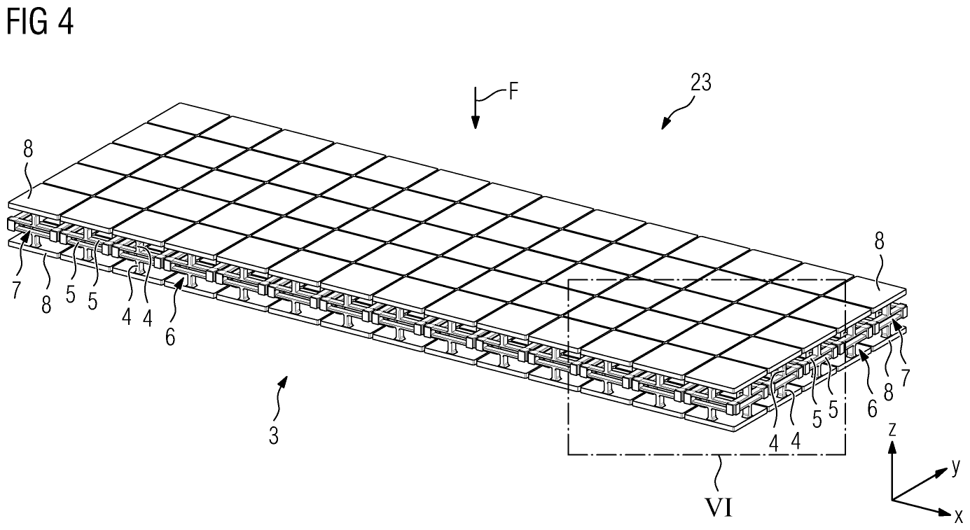

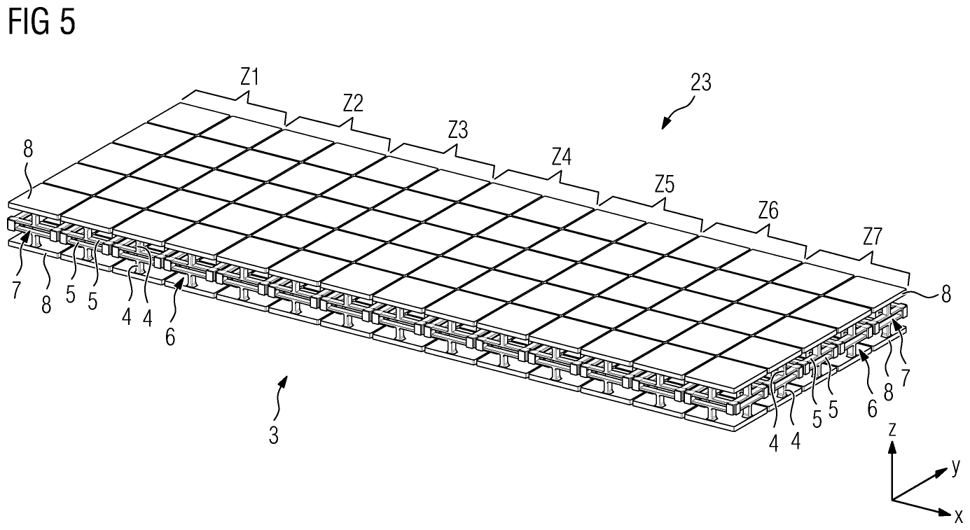

Sole element data can be provided which describe a geometric/constructive design of the sole element 23 which is formed, at least in portions, in particular completely, by a structural element arrangement 6 comprising a plurality of interconnected strut-like or strut-shaped structural elements 5. The sole element 23 can thus be manufactured in the form of a structural element arrangement 6 described by the sole element data, which comprises, at least in portions, in particular completely, by a plurality of interconnected strut-like or strut-shaped structural elements 5. As is explained in greater detail in the following, in connection with the embodiments according to FIG. 4 ff, different configurations of a corresponding structural element arrangement 6 make it possible to purposely achieve different structural, i.e. in particular mechanical, properties of the sole element 23 and thus of the sole/insole part 21.

The insole element 22 can be manufactured having an insole element region which is formed around an edge, at least in portions, optionally completely, and which is raised in particular with respect to a reference plane (this can be defined for example by a contact surface region 4 of the insole element 22), which insole element region surrounds the foot of a wearer around the periphery (of the foot), at least in portions, in the worn state of the sole/insole part 21.

The sole element 23 and/or the insole element 22 can be manufactured at least in portions, optionally completely, having a plurality of zones Z1-Zn having different geometric/constructive and/or different structural properties, i.e. in particular mechanical properties. For example, as indicated merely by way of example in FIG. 1, at least one zone Z1 can be formed for a forefoot region, at least one zone Z2 for a midfoot region, and at least one zone Z3 for a hind foot region (heel region), which regions may differ in their structural properties, i.e. in particular in their mechanical properties. Corresponding zones Z1-Zn can in particular be designed so as to be individualised in a wearer-specific manner.

Returning to FIG. 3, it should be added that, in connection with the production of a shoe 25, in an optional third step of the method (cf. step S3) manufacture or provision of at least one shoe construction element 27, in particular a shoe construction element that forms a component of a shoe upper, can take place, and in an optional fourth step of the method (cf. step S4) connection of the sole/insole part 21 to the at least one shoe construction element 27, in particular the shoe construction element that forms a component of a shoe upper, can take place, forming the shoe 25 to be manufactured.

According to the method, in step S3 a further shoe construction element 27 which encloses the foot of a wearer, in particular the instep of the foot of a wearer, at least in portions, optionally completely, can be manufactured or provided. Therefore, completely closed shoes, partially closed shoes, or open shoes, can be manufactured using the method.

According to the method, in step S3 a further shoe construction element 27 which is formed at least in portions, optionally completely, of a textile material structure, in particular a knitted fabric or woven fabric, can be manufactured or provided. The sole/insole part can thus be connected to a further shoe construction element which is formed at least in portions, optionally completely, of a textile material structure, in particular a knitted fabric or woven fabric.

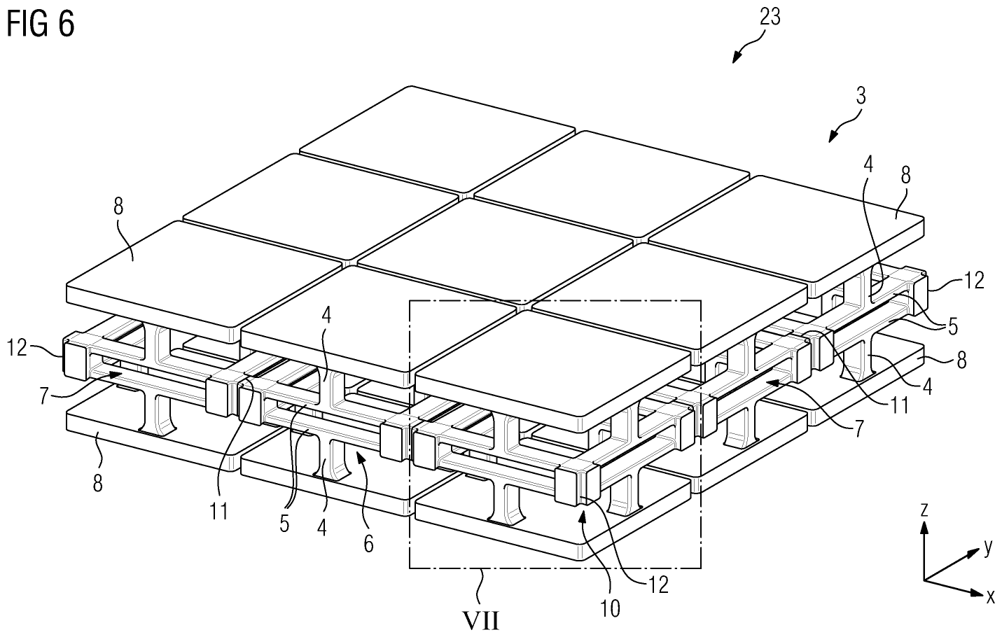

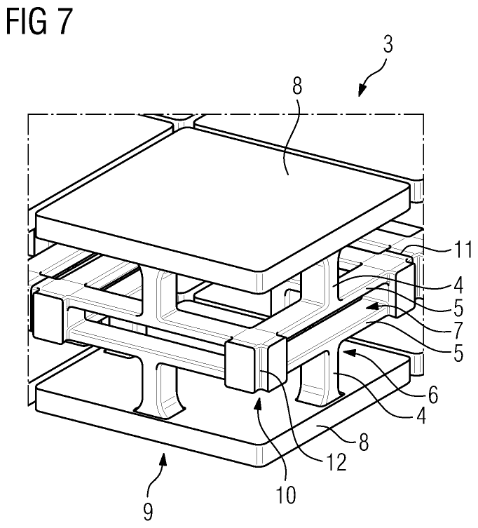

FIG. 4 is a schematic perspective view of a sole element 23 for a sole/insole part 21 according to an embodiment. A detail VI of the sole shown in FIG. 4 is shown in an enlarged view in FIG. 6; a detail VII of the detail VII shown in FIG. 6 is shown in an enlarged view in FIG. 7.

It is clear on the basis of FIGS. 4-7 that the sole element 23 is formed by a structural element arrangement 3 or comprises a structural element arrangement 3. The structural element arrangement 3 is formed by a plurality of interconnected strut-like or strut-shaped structural elements 4, 5 or comprises a plurality of interconnected strut-like or strut-shaped structural elements 4, 5.

The strut-like or strut-shaped geometric/constructive basic shape of the structural elements 4, 5 results from the elongate basic shape of the structural elements 4, 5. In the embodiments shown in the drawings, the cross-sectional geometry of the structural elements 4, 5 is polygonal, i.e. in particular square; however, other, i.e. for example circular or round, cross-sectional geometries are in principle also conceivable.

The structural properties of the sole element 23, i.e. in particular the mechanical properties of the sole element 23 that define the damping properties or the degree of hardness or deformation, substantially result from the geometric/constructive construction of the structural element arrangement 3, i.e. in particular the arrangement and/or orientation of the structural elements 4, 5. Accordingly, the structural properties of the sole element 23, i.e. in particular the mechanical properties of the sole element 23 that define the damping properties or the degree of hardness or deformation, can be purposely set by purposeful selection or variation in the arrangement and/or orientation of the structural elements 4, 5.

In particular, a purposeful selection by region or zone, or a purposeful variation, by region or zone, of the arrangement and/or orientation of respective structural elements 4, 5 makes it possible to achieve any number of regions or zones (cf. FIG. 5, in which, by way of example, a uniform arrangement of seven different zone Z1-Z7 is shown; a non-uniform arrangement of more or fewer than seven zones would of course also be conceivable), i.e. for example one or more regions or zones Z1, Z2 for a forefoot region, one or more regions or zones Z3, Z4, Z5 for a midfoot region, and one or more regions or zones for a hind foot region Z6, Z7 (heel region), having different structural properties, i.e. in particular different mechanical properties. The sole element 23 can thus have structural properties, i.e. in particular mechanical properties, which are or can be adapted individually for a wearer, i.e. in particular also for a particular foot of a wearer.

It can be seen that the structural element arrangement 3 comprises first structural elements 4 which are arranged or formed in a first spatial direction or spatial orientation (vertical spatial direction or spatial orientation, z-direction), and second structural elements 5 which are arranged or formed in a second spatial direction or spatial orientation (horizontal spatial direction or spatial orientation, x-direction, y-direction) that is different from the first spatial direction or spatial orientation. The first spatial direction or spatial orientation is a vertical spatial direction or spatial orientation defined by a vertical spatial axis, the second spatial direction or spatial orientation is a horizontal spatial direction or spatial orientation defined by a horizontal spatial axis. The first structural elements 4 are accordingly arranged or oriented so as to be at right-angles to the second structural elements 5 (and vice versa).

In particular on account of the different arrangement and orientation thereof, the first and second structural elements 4, 5 are differently functionalised, i.e. they differ in terms of their function. The first structural elements 4 are arranged or designed to transmit forces (cf. arrow F in FIG. 4) acting on the sole element 23 during use as intended and are thus also referred to as force transmission elements. The second structural elements 5 are arranged or designed to damp forces acting on the sole during use as intended and are thus also referred to as damping elements.

On account of the arrangement and orientation of first and second structural elements 4, 5 shown in the drawings, combined force transmission/damping substructures 6 are formed. On account of the first structural elements 4 which function as force transmission elements, a respective substructure 6 has both force transmission properties and, on account of the second structural elements 5 which function as damping elements, also damping properties. A respective substructure 6 is thus characterised both by a force transmission function and by a damping function.

In the embodiments shown in FIG. 4 ff, the substructure 6 is formed by two first structural elements 4, i.e. two force transmission elements, and two second structural elements 5, i.e. two damping elements. The two force transmission elements (first structural elements 4) are arranged in a vertical orientation, in parallel with the direction of a force acting on the sole element 23 (direction of action of force) during use as intended of the sole/insole part 21. The two damping elements (second structural elements 5) are arranged in a horizontal orientation, transversely to the direction of the force acting on the sole element 23 (direction of action of force) during use as intended of the sole/insole part 21.

It is evident that the two damping elements (second structural elements 5) of a substructure 6 are arranged or formed so as to be in parallel with one another, forming a damping element arrangement 7. The damping properties of a respective damping element arrangement 7 result in particular from the thickness of the damping elements forming said arrangement, as well as the spacing between the damping elements forming said arrangement. Therefore for example the thickness of the damping elements, and the mutual spacing thereof, provide parameters for purposeful selection and setting of particular damping properties of a damping element arrangement 7. Selecting and setting the parameters accordingly makes it possible for, for example, a particular deformation, i.e. in particular a maximum deformation, for example a maximum deformation of 1 mm, of the damping element arrangement 7 to be defined for a particular force acting on the damping element arrangement 7.

Forces are introduced into a respective damping element arrangement 7 by means of respective force transmission elements (first structural elements 4) of a respective substructure 6. For this purpose, a first or upper force transmission element is arranged relative to a first or upper damping element, adjacent thereto, such that forces can be transmitted into the damping element arrangement 7 thereby. A second or lower force transmission element is arranged relative to a second or lower damping element, adjacent thereto, such that forces can be transmitted thereto from the damping element arrangement 7.

On account of the vertical orientation of the force transmission elements and the horizontal orientation of the damping elements, a double T-structure results for a substructure 6, in which the horizontally extending portions of the “T”, formed by the damping elements, are designed so as to be arranged in a manner lying on one another, and the vertically extending portions of the “T”, formed by the force transmission elements, are designed so as to be arranged in a manner aligned with one another in the vertical direction.

It is evident that the structural element arrangement 3 comprises a plurality of corresponding substructures 6, i.e. a plurality of substructures 6. The substructures 6 are arranged and oriented in a (common) plane (x-y plane) of the sole element 23. A plurality of substructures 6 can form a substructure arrangement 10.

In addition to the structural elements 4, 5, the sole element 23 comprises a plurality of planar, in particular plate-like or plate-shaped, force introduction elements 8 designed for introducing, into respective substructures 6, a force which acts on the sole element 23 during use as intended. In the embodiments shown in the drawings, the force introduction elements 8 have a polygonal, i.e. a square, basic shape. It can be seen that respective force introduction elements 8 are arranged or formed on a upper and/or a lower face of the structural element arrangement 3; in the embodiment shown in the drawings, first or upper force introduction elements 8 are provided which are arranged or formed on an upper face of the structural element arrangement 3, and second or lower force introduction elements 8 are provided which are arranged or formed on lower face of the structural element arrangement 3.

It can be seen that respective force introduction elements 8 arranged or formed on an upper or a lower face of a structural element arrangement 3 are not directly interconnected. A space is formed between force introduction elements 8 that are arranged or formed on an upper or a lower face of a structural element arrangement 3, so as to be directly adjacent. As a result, introducing a force into a first force introduction element 8 does not necessarily cause the introduction of a force into a second force introduction element 8 that is arranged or formed so as to be directly adjacent to the first force introduction element 8.

The force introduction elements 8 are designed for introducing a force, acting on the sole element 23, into the force transmission elements (first structural elements 4) of a respective substructure 6, and accordingly connected to at least one force transmission element; thus, at least one force transmission element is connected to respective force introduction elements 8. The respective force transmission element typically protrudes, in the vertical direction, from an upper or lower face of a respective force introduction element 8 facing the structural element arrangement 3, in the direction of the damping elements or a respective damping element arrangement 7.

A unit cell 9 of the sole element 23, shown in FIG. 7, is formed by corresponding force introduction elements 8 and corresponding substructures 6. A unit cell 9 can be referred to or considered as a geometric/constructive basic module of the sole element 23. It can be seen from FIG. 7 that the unit cell 9 is formed by a plurality of substructures 6 which are arranged and oriented in a (common) plane of the sole element 23 and so as to be rotated or offset relative to one another by a particular angle, as well as a plurality of force introduction elements 8 that are arranged or formed on the upper and lower face of said substructures 6. The substructures 6 are interconnected in the region of the ends thereof by means of connection regions 12, which are block-like, by way of example, and which are shown in the embodiments in FIG. 4 ff.

The unit cell 9 shown in the embodiments shown in FIG. 4 ff comprises four substructures 6 which are arranged and oriented so as to be rotated or offset relative to one another by 90°, which substructures form a substructure arrangement 10. The first or upper force introduction element 8 is arranged or formed on the top of said substructure arrangement 10, and the second or lower force introduction element 8 is arranged or formed on the bottom thereof. The unit cell 9 thus comprises four substructures 6 and two force introduction elements 8. The substructures 6 form the side faces of the unit cell 9, the first or upper force introduction element 8 forms the upper face, the second or lower force introduction element 8 forms the lower face of the unit cell 9.

The unit cell 9 has a cuboid-like or cuboid-shaped or cube-like or cube-shaped basic shape. The edge or side length of the unit cell 9 can for example be in a range between 5 and 15 mm, in particular between approximately 10 mm. The height of the unit cell 9 can also be for example in a range between 5 and 15 mm, in particular between approximately 10 mm.

The structural properties, i.e. in particular the mechanical properties, of a respective unit cell 9 can be or are defined by the structural properties, i.e. in particular the mechanical properties, the components of the unit cell 9, as well as the arrangement and orientation thereof relative to one another.

It can be seen from FIG. 4 ff that the sole element 23 can comprise a plurality of unit cells 9 which are identical with respect to the geometric/constructive properties thereof, i.e. in particular the dimensions thereof. Unit cells 9 that are arranged so as to be directly adjacent are interconnected by means of a connection region 11. In the embodiments shown in FIG. 4 ff, a corresponding connection region 11 is formed in the region of respective damping elements or damping element arrangements 7 of unit cells 9 that are arranged so as to be directly adjacent.

Unit cells 9 arranged in identical zones of the sole element 23 typically exhibit the same structural properties, i.e. in particular the same mechanical properties. Unit cells 9 arranged in different zones of the sole element 23 can exhibit different structural properties, i.e. in particular different mechanical properties.

Accordingly, an arrangement of unit cells 9 with are identical or different with respect to the structural properties thereof, i.e. in particular mechanical properties, makes it possible for zones having the same or different structural properties, i.e. in particular different mechanical properties, damping, degrees of hardness, degrees of deformation, etc., to be formed. As has already been explained in conjunction with the embodiment shown in FIG. 5, the sole element 23 can be divided into a plurality of zones having different structural properties. As mentioned, the unit cells 9 associated with a particular zone typically exhibit the same geometric/constructive properties and the same structural properties.

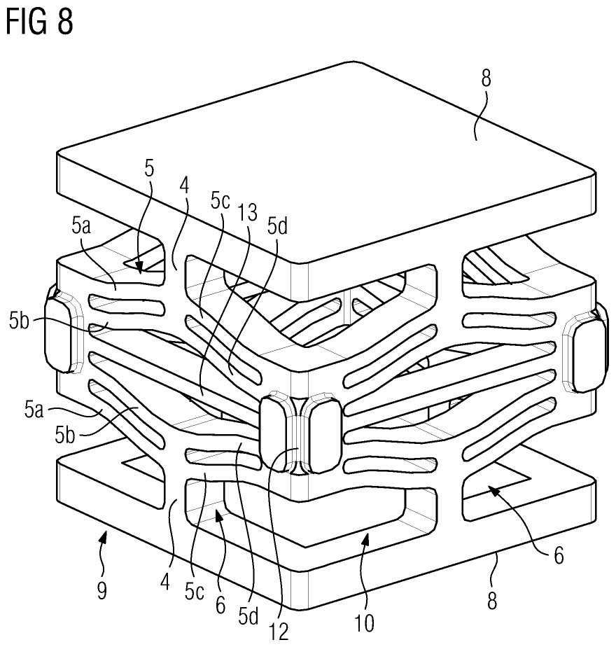

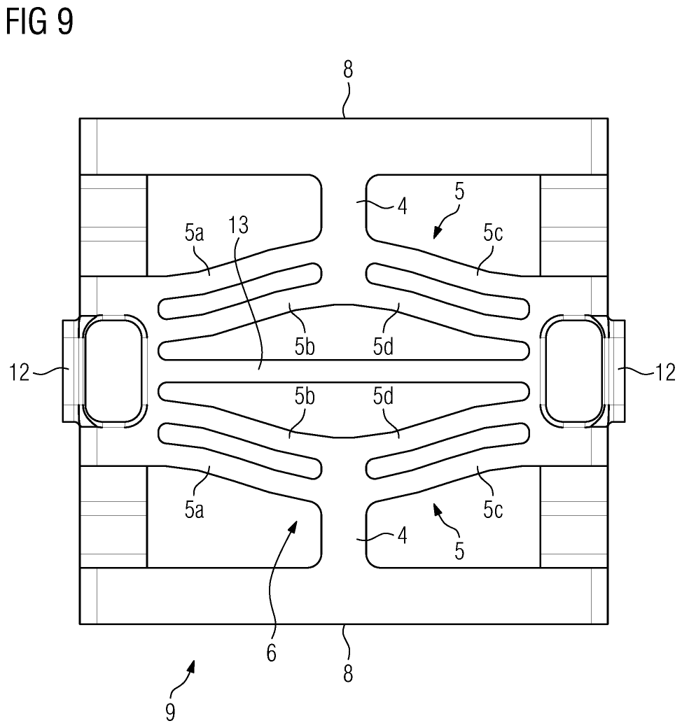

FIGS. 8 and 9 show a structural element arrangement 3 or a unit cell 9 according to a further embodiment. The structural element arrangement 3 and/or the unit cell 9 is shown in a perspective view in FIG. 8 and in a front view in FIG. 9.

The embodiment shown in FIGS. 8 and 9 is an alternative to the embodiment of a unit cell 9 shown in FIG. 7; therefore, the unit cell 9 according to the embodiment shown in FIGS. 8 and 9 could also be used instead of the unit cell 9 according to the embodiment shown in FIG. 7, in order to form a sole element 23. A sole element 23 which comprises both unit cells 9 according to the embodiment shown in FIG. 7, and unit cells 9 according to the embodiment in FIGS. 8 and 9, is also conceivable.

It can be seen from the embodiment shown in FIGS. 8 and 9 that the second structural elements 5 can be designed so as to be segmented. Similar applies, even if not shown, for the first structural elements 4. The second structural elements 5 can thus be formed by a plurality of structural element segments 5a-5d which are arranged so as to extend in parallel. A segmented design of the second structural elements 5 makes it possible for the structural properties of the structural element arrangement 3 and thus of the sole element 23, i.e. in particular the mechanical properties of the sole element 23, to be influenced in a more purposeful manner.

It is clear that structural element segments 5a-5d which are arranged or formed in parallel can be arranged or formed in pairs. The second structural elements 5 can thus comprise a plurality of structural element segments 5a-5d which are arranged or formed so as to be in parallel. In the embodiment shown in FIGS. 8 and 9, two structural element segments 5a-5d which are arranged or formed so as to be in parallel form a structural element segment pair. Each second structural element 5 is thus formed by two structural element segment pairs or comprises two structural element segment pairs.

It can furthermore be seen from the embodiment shown in FIGS. 8 and 9 that, in principle independently of the segmented design thereof, the second structural elements 5 (similar also applies for the first structural elements 4) can be arranged to as to extend obliquely with respect to a horizontal or vertical reference axis or plane. A course of respective structural elements 5, or for the case of the segmented design of respective structural elements 5, shown in FIGS. 8 and 9, which course is arranged so as to be correspondingly oblique with respect to a horizontal or vertical reference axis or plane, also constitutes a measure for purposeful influencing of the structural properties of the structural element arrangement 3 or of the sole element 23, i.e. in particular the mechanical properties of the structural element arrangement 3 or of the sole element 23, since in particular other damping properties of the structural element arrangement 3 can result from the oblique course. Accordingly, in particular the as damping elements or the second structural elements 5 can be arranged so as to extend obliquely with respect to a horizontal or vertical reference axis or plane. It is the case here, as shown in FIGS. 8 and 9, that upper second structural elements 5, with respect to an upper face of the sole element 23, are arranged or formed so as to extend obliquely, with respect to a corresponding reference axis or plane, at a different angle compared with lower second structural elements 5.

FIGS. 8 and 9 show a combination of the segmented design of the second structural elements 5 and the course of the second structural elements 5 which is arranged so as to be oblique with respect to a horizontal or vertical reference axis or plane. The second structural elements 5 are therefore formed by a plurality of structural element segments 5a-5d which are arranged so as to extend in parallel, and the structural element segments 5a-5d are arranged so as to extend obliquely with respect to a horizontal or vertical reference axis or plane.

For the respective structural element segment pairs of a second structural element 5, it is the case that a first structural element segment pair is arranged so as to extend at a first angle with respect to a horizontal or vertical reference axis or plane, and a second structural element segment pair of two structural element segments 5a-5d is arranged so as to extend at a second angle with respect to the horizontal or vertical reference axis or plane. The wedge-like or wedge-shaped geometry of the second structural elements 5, shown in FIGS. 8 and 9, results in this way, wherein the wedge flanks are formed by respective structural element segment pairs.

It is clear that there is a mirror-symmetrical arrangement of respective structural element segment pairs that form a respective second structural element 5. The angle between respective structural element segment pairs is obtuse, i.e. typically more than 90°, in particular more than 130°, optionally more than 150°.

Furthermore, optional third structural elements 13 are visible in the embodiment shown in FIGS. 8 and 9. The structural element arrangement 3 can thus furthermore comprise third structural elements 13 which differ, in terms of function, from the first and second structural elements 4, 5. The third structural elements 13 are arranged or designed as tensile force transmission elements designed for transmitting tensile forces that act on the sole element 23 or the structural element arrangement 3, in particular in the longitudinal direction of the sole element 23 or of the structural element arrangement 3, and/or as tensile force transmission elements designed for transmitting tensile forces resulting inside the sole element 23 or the structural element arrangement 3, in particular acting in the longitudinal direction of the sole element 23 or the structural element arrangement 3. The third structural elements 13 can thus also be referred to or considered as tensile force transmission elements.

It can be seen that respective third structural elements 13 are arranged or formed between two second structural elements 5, in each case, and arranged in a horizontal spatial direction or spatial orientation defined by a horizontal spatial axis.

Individual, a plurality of, or all the features described in connection with a particular embodiment can be combined, as desired, with individual, a plurality of, or all the features of at least one other embodiment.

1. A method for manufacturing a combined sole/insole part (21) for a shoe (25), which comprises a sole element (23) and an insole element (22) that is formed integrally therewith, said method comprising the steps of:
providing insole element data which describe the geometric/constructive design of an insole element of a sole/insole part to be manufactured, wherein the insole element data were generated on the basis of foot data which describe, at least in portions, the morphology of at least one foot of a wearer;
providing sole element data which describe the geometric/constructive design of a sole element of the sole/insole part (21) to be manufactured; and
additively manufacturing the combined sole/insole part on the basis of the insole element data and the sole element data.

2. The method according to claim 1, wherein the combined sole/insole part (21) is manufactured in a single additive manufacturing process.

3. The method according to claim 1, wherein the sole element data are provided which describe a geometric/constructive design of the sole element (23) which is formed, at least in portions, by a structural element arrangement (3) comprising a plurality of interconnected strut-like structural elements.

4. The method according to claim 1, wherein the insole elements are provided which describe a geometric/constructive design of the insole element which is formed at least in portions, in particular completely, by an ergonomic shaping selected in view of the morphology of the at least one foot described by the foot data.

5. The method according to claim 1, wherein the insole element is manufactured having an insole element region which is formed around an edge, at least in portions, in particular with respect to a reference plane, which insole element region surrounds the foot of a wearer, at least in portions, in the worn state of the combined sole/insole part.

6. The method according to claim 1, wherein the sole element and/or the insole element is manufactured at least in portions, having a plurality of zones (Z1-Zn) having different geometric/constructive and/or different mechanical properties.

7. The method according to claim 1, wherein the sole element is manufactured as a midsole or as an outsole.

8. The method according to claim 1, wherein the combined sole/insole part is manufactured at least in portions, from a plastics material.

9. The method according to claim 1, wherein the combined sole/insole part is manufactured by means of a stereolithographic process, binder jetting process, fused deposition modelling (FDM) process, or a continuous liquid interface production (CLIP) process.

10. A combined sole/insole part manufactured according to the method of claim 1.

11. A method for manufacturing a shoe comprising the steps of:
manufacturing a combined sole/insole part for a shoe according to the method of claim 1, or
providing a combined sole/insole part manufactured according to the method of claim 1;
manufacturing at least one shoe construction element that forms a component of a shoe upper, or
providing at least one a shoe construction element, in particular a shoe construction element that forms a component of a shoe upper; and
connecting the manufactured or provided combined sole/insole part to the at least one manufactured or provided further shoe construction element, in particular the shoe construction element that forms a component of a shoe upper, forming the shoe to be manufactured.

12. The method according to claim 11, wherein a further shoe construction element which encloses the foot of a wearer, in particular the instep of the foot of a wearer, at least in portions, is manufactured or provided.

13. The method according to claim 11, wherein a further shoe construction element which is formed at least in portions, of a textile material structure, in particular a knitted fabric or woven fabric, is manufactured or provided.

14. A shoe manufactured according to the method according to claim 1.
